(19) United States
(12) Patent Application Publication
(10) Pub. No.: US 2011/0246334 A1
(43) Pub. Date: Oct. 6, 2011

(54) Connecting Consumers with Providers

(76) Inventors: Ido Schoenberg, Boston, MA (US); Roy Schoenberg, Boston, MA (US)

(21) Appl. No.: 13/077,026

(22) Filed: Mar. 31, 2011

Related U.S. Application Data
(60) Provisional application No. 61/320,100, filed on Apr. 1, 2010.

(51) Int. Cl. G06Q 30/00

(52) U.S. Cl. 705/27.1

(57) ABSTRACT

A computer-implemented method includes receiving a request from a consumer to purchase consultation time from a service provider having specified attributes, the service providers associated with a private business; generating a graphical user interface that when rendered on a display device depicts an image marking the graphical user interface with a indicia of the private business and one or more input elements for searching for the one or more service providers associated with the private business; determining by a computer system one or more service providers associated with the private label that are presently available to engage in a real-time consultation with the consumer; searching by the computer system a database of attributes for the one or more presently available service providers selling consultation time; and identifying a presently available service provider associated with at least some of attributes included in the request to purchase consultation time.

### CLAIM OF PRIORITY

This application claims priority under 35 U.S.C. §119(e) to provisional U.S. Patent Application 61/320,100, filed on Apr. 1, 2010, the entire contents of which are hereby incorporated by reference.

### BACKGROUND

Systems have been developed to provide services that connect consumers and their providers over the Internet and the World Wide Web. Some systems use e-mail messaging and web-based forms to increase the level of connectivity between a member of a health plan and his assigned health care provider. The consumer sends an e-mail or goes to a website that generates and sends a message (typically an e-mail or an e-mail type message) to a local provider.

These types of services have been broadly referred to as “e-visits.” While generally viewed as an addition to the spectrum of services that may be desired by consumers, the benefits of such services are not clear. One of the concerns associated with offering additional communication channels, such as e-mail, is that it can result in over consumption of services, rather than provide for better coordination.

Another system is a brokerage type of system as described in my issued Patent U.S. Pat. No. 7,590,550, which is incorporated herein by reference.

### SUMMARY

In one aspect of the present disclosure, a computer-implemented method includes receiving a request from a consumer to purchase consultation time from a service provider having specified attributes, the service providers associated with a private business; generating a graphical user interface that when rendered on a display device depicts an image marking the graphical user interface with a indicia of the private business and one or more input elements for searching for the one or more service providers associated with the private business; determining by a computer system one or more service providers associated with the private label that are presently available to engage in a real-time consultation with the consumer; searching by the computer system a database of attributes for the one or more presently available service providers selling consultation time; and identifying a presently available service provider associated with at least some of attributes included in the request to purchase consultation time.

Implementations of the disclosure can include one or more of the following features. In some implementations, the method further includes establishing a communication channel between a computer system of the identified service provider and a computer system of the consumer. In other implementations, the attributes for a service provider include one or more of a date on which the consultation time of the service provider is sold and a field related to the consultation provided by the service provider.

In some implementations, the method includes receiving from a computer system of the consumer payment information for purchase of the consultation time; processing the payment information; and crediting an account of the identified service provider with a compensation amount. In other implementations, the service provider is a customer service representative.

In still other implementations, receiving the request to purchase consultation time includes: receiving information indicative of one or more actions performed by the consumer in a graphical user interface generated by the computer system; and detecting, based on the one or more actions, the request to purchase consultation time. In some implementations, the identified service provider is a first type of service provider, and the method further includes: generating a graphical user interface that when rendered on a display device depicts: a first visual representation of the first type of service provider that is available for a first type of consultation with the consumer; and a second visual representation of a second, different type of service provider that is available for a second, different type of consultation with the consumer. In still other implementations, the method further includes sending the consumer a list of video or audio for the consumer to select from to view to assist the consumer in selecting a provider.

In another aspect of the disclosure, one or more machine-readable media are configured to store instructions that are executable by one or more processing devices to perform operations including receiving a request from a consumer to purchase consultation time from a service provider having specified attributes, the service providers associated with a private business; generating a graphical user interface that when rendered on a display device depicts an image marking the graphical user interface with a indicia of the private business and one or more input elements for searching for the one or more service providers associated with the private business; determining one or more service providers associated with the private label that are presently available to engage in a real-time consultation with the consumer; searching a database of attributes for the one or more presently available service providers selling consultation time; and identifying a presently available service provider associated with at least some of attributes included in the request to purchase consultation time. Implementations of this aspect of the present disclosure can include one or more of the foregoing features.

In still another aspect of the disclosure, an electronic system includes one or more processing devices; and one or more machine-readable media configured to store instructions that are executable by the one or more processing devices to perform operations including: receiving a request from a consumer to purchase consultation time from a service provider having specified attributes, the service providers associated with a private business; generating a graphical user interface that when rendered on a display device depicts an image marking the graphical user interface with a indicia of the private business and one or more input elements for searching for the one or more service providers associated with the private business; determining one or more service providers associated with the private label that are presently available to engage in a real-time consultation with the consumer; searching a database of attributes for the one or more presently available service providers selling consultation time; and identifying a presently available service provider associated with at least some of attributes included in the request to purchase consultation time. Implementations of this aspect of the present disclosure can include one or more of the foregoing features.

All or part of the foregoing can be implemented as a computer program product including instructions that are stored on one or more non-transitory machine-readable storage media, and that are executable on one or more processing devices. All or part of the foregoing can be implemented as an apparatus, method, or electronic system that can include one or more processing devices and memory to store executable instructions to implement the stated functions.

The details of one or more implementations are set forth in the accompanying drawings and the description below. Other features, objects, and advantages will be apparent from the description and drawings, and from the claims.

### BRIEF DESCRIPTION OF THE FIGURES

FIG. 1 is a diagrammatic view of an engagement brokerage service.

FIGS. 2, 3A-3C, 5 and 7 are flow charts of processes used in an engagement brokerage system.

FIG. 4 is a table of sample criteria used in an engagement brokerage system.

FIGS. 6 and 8 are example graphical user interfaces generated the brokerage system.

FIG. 9 is a block diagram of a computer (computer system) showing exemplary components that can be used for the brokerage system and/or client systems.

Like reference symbols in the various drawings indicate like elements.

### DETAILED DESCRIPTION

Overview

The system described below provides an integrated information and communication platform that enables consumers of services to identify and prioritize service providers presently available for a consultation (e.g., via live video and/or live audio and/or the telephone and/or live chat and/or via secure message) with the consumer. Through the system, dynamic populations (e.g., consumers and service providers) engage in interactions at times that are separately convenient for the consumers and the service providers, because the system matches real-time availability of the service providers with consumers' real-time requests to engage with the service providers. Consumers at clients systems 122 are able to interact on-line with a service provider, even when the two parties are geographically separated. This integrated platform is referred to herein as an engagement brokerage service (brokerage).

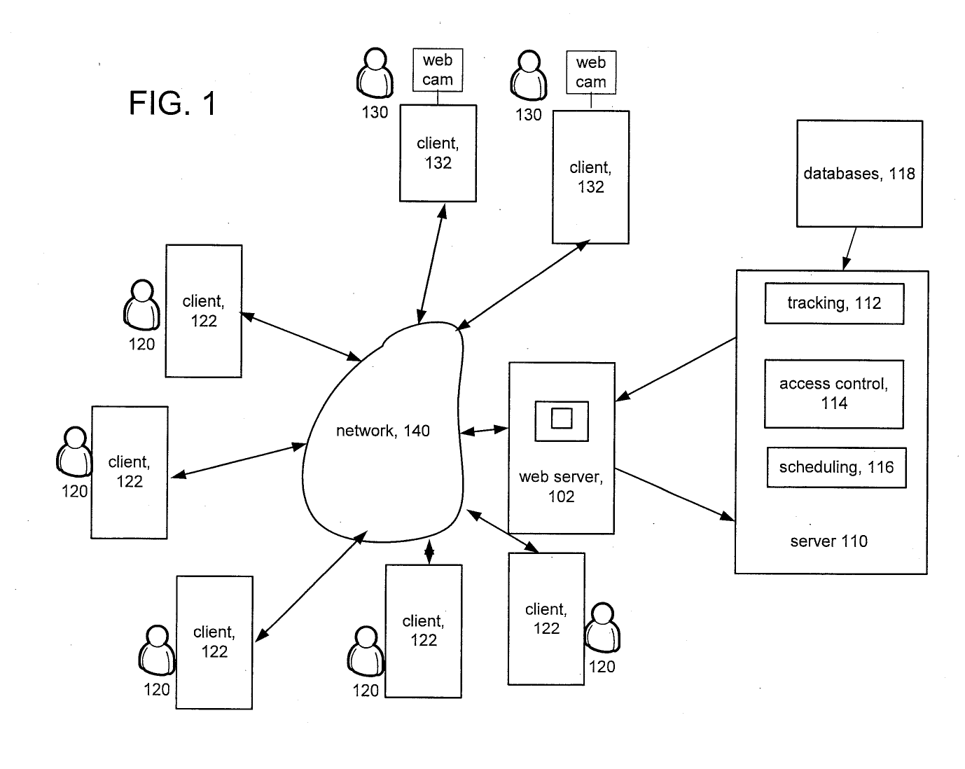

FIG. 1 shows an example system 100 implementing the brokerage service for live video and/or live audio. The system 100 includes a computerized system or server 110 for making connections between consumers 120, at client systems 122, and service providers 130, at client systems 132 including, e.g., web cams or the like over a network 140, e.g., the Internet or other types of networks. The computerized system 110 may operate as a service running on a web server 102.

The computerized system 110 includes an availability or presence tracking module 112 for tracking the availability of the service providers 130. Availability or presence is tracked actively or passively. In an active system, one or more of the service providers 130 provides an indication to the computerized system 110 that the one or more service providers are available to be contacted by consumers 120 and an indication of the mode by which the provider may be contacted. In some examples of an active system, the provider's computer, phone, or other terminal device periodically provides an indication of the provider's availability (e.g., available, online, idle, busy) to the system 110 and a mode (e.g., text, voice, video, etc.) by which he can be engaged. In a passive system, the computerized system 110 presumes that the service provider 130 is available by the service provider's actions, including connecting to the computerized system 110 or registering the provider's local phone number with the system. In some examples of a passive system, the system 110 indicates the provider 130 to be available at all times until the provider logs off, except when the provider is actively engaged with a consumer 120.

The computerized system 110 also includes one or more processes such as the tracking module 112 and a scheduling module 116. The system 110 accesses one or more databases 118. The components of the system 110 and the web server 102 may be integrated or distributed in various combinations as is commonly known in the art.

Using the system 100, a consumer 120 communicates with a provider 130. The consumers 120 and providers 130 connect to the computerized system 110 through a website or other interface on the web server 102 using client devices 122 and 132, respectively. Client devices 122 and 132 can be any combination of, e.g., personal digital assistants, land-line telephones, cell phones, computer systems, media-player-type devices, and so forth. The client devices 122 and 132 enable the consumers 120 to input and receive information as well as to communicate via video, audio, and/or text with the providers 130.

Providers are, however, often available at times that are not convenient for their consumers, for example, in the event of a last-minute cancellation. Providers also may be available during otherwise idle times, such as when home. The brokerage supplements existing provider availability to allow whichever providers are available at any given time to provide live video/audio to consumers at their request. Instead of relying on the unlikely availability of a specific provider for any given consumer, the brokerage connects the consumer to all online providers capable of addressing the consumer's needs. The brokerage has distinct features including the ability to engage in live communication with a suitable, selectable provider and the ability to do so on-demand

One advantage that the brokerage provides is that the brokerage constantly monitors the availability of a provider for an engagement. In order to achieve such a level of availability, the system assimilates the discretionary or fractional availability windows of time offered by individual providers into a continuous availability perception by consumers. Because many of the services offered to consumers are on-demand, consumers have little expectation that the same provider will be constantly available. However, consumers have an expectation that some provider will be available. As discussed in further detail below, the brokerage system supports a large number of available providers and therefore the system provides tools (e.g., navigational components, links and selection boxes) to assist a consumer in selecting an appropriate provider. In an example, the system may promote searching for service providers by generating a graphical user interface with input elements, including, e.g., text boxes, search boxes, dropdown menus, and so forth.

The system assists the consumer in navigating to an appropriate service provider based on information already associated with the consumer's account and/or the consumer's preferences and/or the consumer's prior service provider selections (e.g., the consumer previously engaged in a service provider with culinary expertise or financial planning expertise). The consumer can select to engage with the next available service provider in a given service provider domain (e.g., the consumer can choose to connect to the next available culinary service provider).

The computerized system 110 provides information and services to the consumers 120 in addition to connecting them with providers 130. The computerized system 110 includes an access control facility 114, which manages and controls whether a given consumer 120 may access the system 110 and what level or scope of access to the features, functions, and services the system 110 will provide.

The consumer 120 uses the system 100 to find out more information about a topic of interest. The computerized system 110 identifies service providers 130 that are available at any given moment to communicate with a consumer about a particular type of content. The computerized system 110 facilitates communication between the consumer 120 and provider 130, enabling them to communicate, for example, via a data-network-facilitated video or voice communication channel (such as Voice over IP), land and mobile telephone network channels, and instant messaging or chat. The availability of one or more providers 130 is tracked, and at the instant a consumer 120 desires to connect and engage in a consultation with a provider (e.g., via live video and/or audio,) the system 110 determines whether a provider is available. If a particular provider 130 is available, the system 110 assesses the various modes of communication that are available (e.g., based on common modes and modes preferred by the provider) and connects the consumer 120 and the provider 130 through one or more of the common modes of communication.

In addition, the system selects a mode of communication to use based in part on the relative utility of the various modes. The preferred mode for an engagement is for both the consumer 120 and the provider 130 to use web-based consoles, as this allows each of the other modes to be used as needed. For example, consumers and providers may launch chat sessions, voice calls, or video chats from within a web-based console. If the provider 130 is not available, the system 110 identifies other available providers 130 that would meet the consumer 120's needs. The system 110 enables the consumer 120 to send a message to the consumer's chosen provider. The consumer can also have the system 110 contact the consumer in the future when the chosen provider is available.

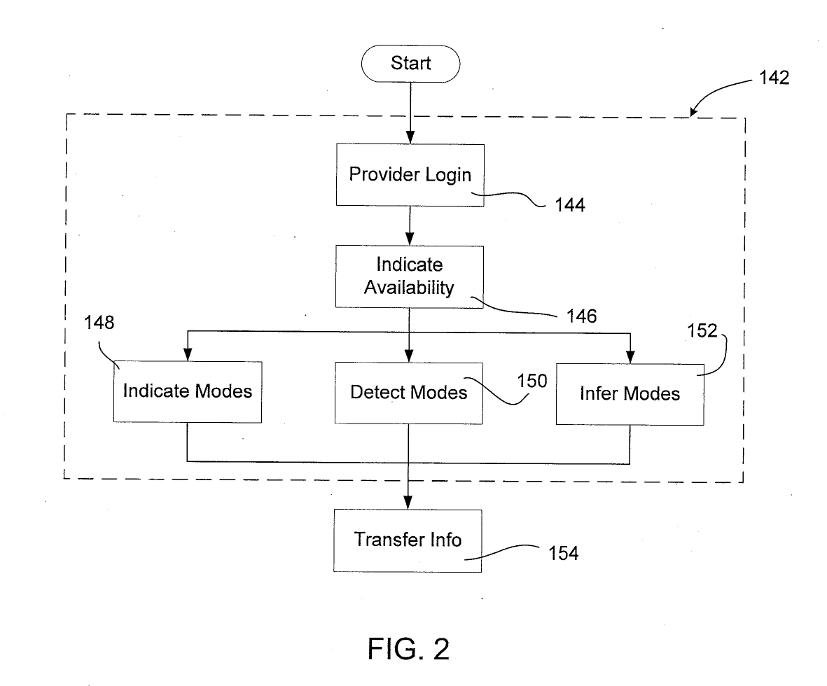

Referring now to FIG. 2, the computerized system 110 tracks 142 the availability of providers 130 and consumers 120. When a provider 130 logs 144 into the system 100, the provider 130 indicates 146 (such as by setting a check box or selecting a menu entry or by responding to a voice prompt) to the tracking module 112 that he or she is available to interact with consumers 120 and to broadcast his or her live video and/or audio. The provider 130 can also indicate 148 to the tracking module 112 (such as by setting a check box or selecting a menu entry or by responding to a voice prompt) the modes (e.g., telephone, chat, video conference) by which a consumer 120 can be connected to the provider 130. Alternatively, the tracking module 114 determines 150 the capabilities of the terminals 122 and 132 the consumer 120 and the provider 130 use to connect to the system (for example, by using a terminal-based program to analyze the hardware configuration of each terminal). Thus, if a provider 130 connects to the system 100 by a desktop computer and the provider has a video camera connected to that computer, the tracking module 112 determines 150 that the provider 130 can be engaged by text (e.g., chat or instant messenger), voice (e.g., VoIP) or video conference. Similarly, if a provider 130 connects to the system using a handheld device such as a PDA, the tracking module 112 determines 152 that the provider 130 can be engaged by text or voice. The tracking module 112 can also infer 152 a provider's availability and modes of engagement by the provider's previously provided profile information and the terminal device through which the provider connects to the system.

Providers participating in the brokerage network can have several states of availability over time. States in which the provider may be available may include on-line, in which the provider is logged-in and can accept new engagements in any mode, on-line (busy), in which the provider is logged-in but is currently occupied in a video or telephonic engagement, and scheduled, in which the provider is offline but is scheduled to be online at a designated time-point and can pre-schedule engagements for it. While not online, the provider can take messages as in offline state. Other states may include off-line, in which the provider is not logged in but can take message-based engagements (i.e., asynchronous engagements), out-of-office, in which the provider is not accepting engagements or messages, and standby, in which the provider is offline and can be paged to Online status by the brokerage network if traffic load demands it (in some examples, consumers see this state as offline).

The operating business model for the provider network employs a remuneration scheme for providers that helps assure that the consumers can find providers in designated professional domains in the online mode. For example, selected providers can be remunerated for being in the standby mode to encourage their on-line availability in case of low discretionary availability by other—providers in their professional domain.

Standby providers are also called into the on-line state when the percentage of on-line (busy) providers in their professional domain exceeds a certain threshold of all providers currently on-line (busy and standby). In some examples, the transition of providers from standby to online and back to standby (in case of over capacity or idle capacity) is an automated function of the system.

The tracking module 112 transfers 154 information about the availability and the communication capability of the consumers 120 and the providers 130 to the scheduling module 116 using, for example, one or more well-known presence protocols, such as Instant Messaging and Presence Service (IMPS), Session Initiation Protocol (SIP) for Instant Messaging and Presence Leveraging Extensions (SIMPLE), and the Extensible Messaging and Presence Protocol (XMPP).

As noted, the system 100 includes access control facilities 114 that control how consumers 120 access the system and to what extent or level the services provided by the system are made available to consumers. The system 100 also stores and provides access to consumer information (e.g., contact information, and preference/profile information to be described later). However, other consumer information would typically be not accessible to the service provider, such as credit rating information, financial information, and credit card information. Similarly, provider information (e.g., biographies, product and service information, and any information the provider wants to make available to consumers) can be made available. The access control facility 114 would prevent unauthorized access to this information.

The brokerage provides compensation for products and services provided. Access to the system 100 may be provided on a subscription basis, with consumers paying a fee (either directly or indirectly through another party) to be provided with a particular level of access to the system. In exchange for providing products or services, the service provider may receive compensation from the consumer. In one embodiment, the consumer pays the operator, which keeps a portion (e.g., a percentage payment or a flat fee) and pays the remainder to the service provider. In another embodiment, the consumer or the service provider pays a flat fee or percentage of the fee for the engagement to the operator. The operator may be paid a flat fee or a percentage of the fee for the engagement transaction. Alternatively, the consumer or the service provider or both may pay a fee (a service fee) to the operator for providing the connection.

### The Consumer Interface

Initiation of an Engagement

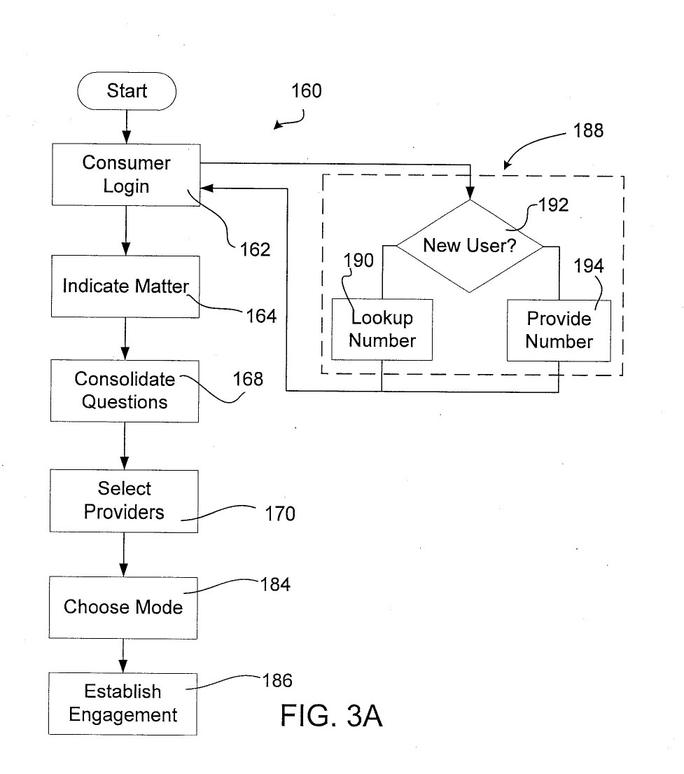

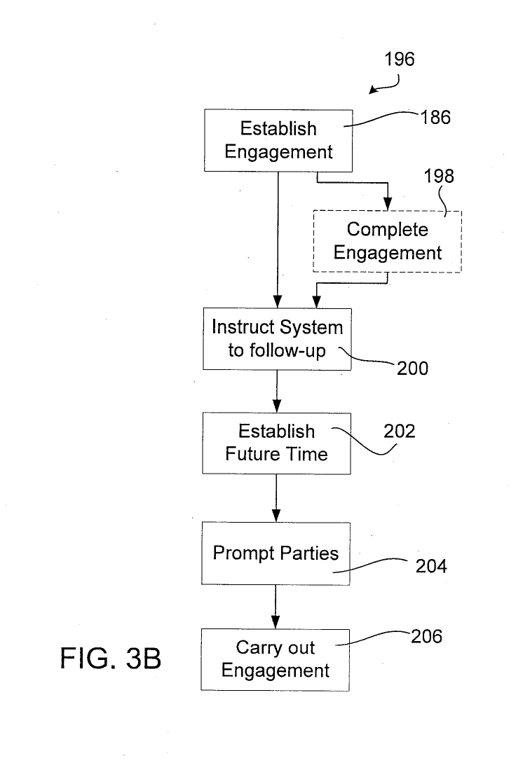

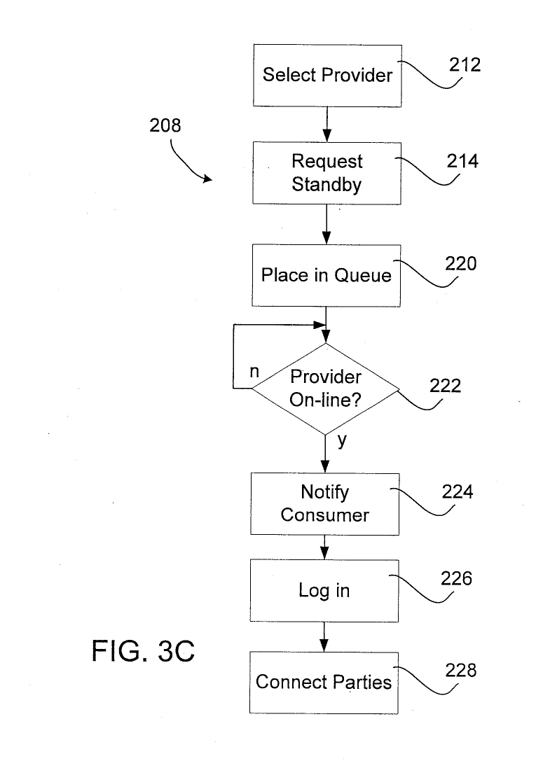

A consumer 120 engages with the brokerage system 100 to access a service provider 130. Several types of engagements may exist. Examples of these are described with respect to flowcharts in FIGS. 3A to 3C.

Referring now to FIG. 3A, a process 160 for establishing a consumer-initiated engagement is shown. In a consumer-initiated engagement, a consumer logs in 162 and communicates 164 the type of consultation with consumer would like to engage in. A component of the brokerage system 100 assists the consumer in consolidating 168 the types of live video or audio the consumer wishes to view and helps select 170 the appropriate providers. A web page includes some initial questions, and another web page provides a user interface for entering additional criteria to find a provider. A results page allows the consumer to select a specific provider from a list of providers identified based on the search criteria. Once a provider is selected and a mode of engagement is chosen 184, the scheduling module 116 establishes 186 the new engagement. In some examples, the brokerage associates 188 a unique identifier with participating consumers which can be used in subsequent interactions with the brokerage. The consumer's brokerage membership number or other similar, pre-existing identification can be used 190. If the consumer does not already have 192 a number, one is generated 194. The unique identifier can be used by the consumers to save their planned engagement for later retrieval.

Referring now to FIG. 3B, a process 196 for establishing a follow-up or prescheduled engagement is shown. Once an engagement is established 186, as in FIG. 3A or as one is completed 198, (FIG. 3B) the two parties signal 200 a component of the system 100, such as the scheduling module 116, to pursue the established engagement or a follow-up engagement at pre-defined schedules or at future time points. The system uses 202 e-mail, automated telephone communication, or any other method of communication to establish a convenient time for both parties to accomplish the follow-up and then prompts 204 them to do so 206.

Referring now to FIG. 3 C, a process 208 for a standby engagement is shown, with a user interface on a web page 210. A standby engagement is similar to a consumer-initialized engagement. In a standby engagement, the consumer selects 212 a provider 180 or type of provider and requests 214 that a component of the system 100, such as the scheduling module 116, to notify the consumer by an appropriate communication, for example, e-mail, text message, or an automated phone call, when the selected provider is online and accepting engagements. In one particular example, the user has chosen to be called and input a phone number and a limit as to how long the user will wait. The consumer request is placed 220 in a queue for the specific requested provider who is off-line (or for a type of provider for which all qualified providers are off-line). When the system determines 222 that the provider is available, the system notifies 224 the consumer. When notified, the consumer logs in 226 and is connected 228 to the provider.

As an option, a standby list for a provider may provide preferential queuing for some consumers. For example, preferential queuing may be provided based on prior engagements with the provider (e.g., preference is given to follow-up engagements) or based on a service tier (e.g., frequent user status) of that consumer. The brokerage can be configured such that it collects information about the consumer (e.g., answers to initial intake questions) and provides the collected information to the specific service provider prior to initiating any further engagements. For example, a consumer can store information during a consumer-initiated engagement as described above, park the information, and wait to be contacted when the specific selected provider is available.

Provider Selection

While the system can assist the consumer in identifying the most appropriate providers, it also allows the consumer to filter the provider list based on his preference and access a view of a provider availability matrix that changes as providers go on and off line.

Various criteria are used to filter the available providers. Basic details indicate the consumer's preference for the type and gender of the provider and what modes of communication the consumer wants to be able to use. The user can also specify demographics including location and languages spoken. Qualifications may include years of experience and various other criteria. A consumer can also use a search box to search for a provider by name.

Consumers may select providers according to the type of consultation that is sought and attributes of the provider, such as a geographical area where the provider is located. Any metrics within the provider profile (discussed below) can be used to define a list of providers that meet the consumer's preferences.

Once the consumer enters her search criteria 176, the results are shown on the web page. As mentioned, a list of providers is presented. This list may indicate each providers name and rating and whether the provider is available. For the selected provider, additional details are shown, including her picture, specialty, demographic information, what types of connections she can use for an engagement, and personal information. Tools allow the consumer to initiate or schedule an engagement and/or view a live video/audio.

Providers already associated with the consumer may appear on the consumers' short list. When reviewing the list of historical engagements, consumers are able to access the engagement audit and the ranking they have attributed to any engagements in the past.

Once a consumer has defined a collection of criteria to filter and find a provider, the system can offer tools to shorten the process in the future. Consumers may be able to save criteria-sets as named searches and benefit from notifications when a search list surpasses a certain level of availability that may encourage the consumer to log in and communicate with a provider.

Modes of Engagement

The brokerage allows consumers to engage provider's “on demand” based on provider availability. Engagements can be established in various ways, including:

1. Asynchronous correspondence—The lowest level of true provider interaction is by way of secure messaging. The question or topic of the engagement is sent to a selected provider (whether online or not) and can be answered by this provider at her leisure. Turnaround times are monitored by the system and are part of the credentials of the provider used for her selection by consumers. The system informs the consumer once a response has been received and can allow the consumer to redirect the question if he needs more urgent response time. For example, typical types of asynchronous correspondence include e-mail, instant messaging, text-messaging, voice mail messaging, VoIP messaging (i.e., leaving a message using VoIP), and paper letters (e.g., via the U.S. Postal Service).

2. Synchronous correspondence—Several forms of synchronous correspondence allow the consumer and the provider to engage in real-time discussions.

3. Synchronous text correspondence—This may be referred to as a “Chat” module where both sides of the engagement type their entries in response to each others' entries. The form of communication may be entirely text based but is still a live communication. Examples include instant messaging and SMS messaging.

4. Web-based streaming live video—The use of broadband network connections allows for real-time voice and video transmission over the Internet. Web-based teleconferencing may use VoIP, SIP, and other standard or proprietary technologies. Small digital cameras, referred to as webcams, attached to or built in to personal computers or laptops can be used for this purpose and can be provided by standard software or by custom software provided by the brokerage. Alternatively, dedicated video conferencing communication equipment or telephones with built-in video capabilities can be used.

5. Telephonic conferencing—Consumers who wish for a direct telephonic communication with a provider or who are not comfortable using their computer may use a traditional telephone for interaction with a provider. The consumer may use a dial-in number and an access code that connects him to the brokerage's servers. Providers are linked to the servers via VoIP, other data-network-based voice systems, or their own telephones. Telephonic conferencing may also allow consumers to request “call me now” functions, in which the provider calls the consumer (directly or through the brokerage).

Engagement Redirection

In some examples, a consumer redirects an active engagement to another provider or provider type. A consumer may also redirect an engagement to employ a different mode of communication with the current provider (e.g., move from a text chat to a phone conversation).

Provider Enrollment

Service providers are the individuals responding to consumers queries and participating in engagements and streaming live video/audio over the network. Providers agree to the terms of the brokerage, such as payment for their time in performing engagements, the protocol of conduct desired, and the ramification and distribution of liability in case of violations of that protocol.

Prior to joining the brokerage network, a provider establishes a profile that that is searchable by consumers. The profile is used for several purposes, including determining the relative cost of the provider's time to either the consumer or the brokerage sponsor, and providing consumers with information that may be relevant to their choice to engage one provider versus another. The provider's profile may also be used to allow a provider (e.g., a celebrity) to establish a forum in which consumers (e.g., fans) may bid for the provider's time. In one particular example, a celebrity wants to auctions a predefined period of time (e.g., ten minutes) in which the celebrity engages in a consultation (e.g., a discussion) with a consumer and sends the proceeds of the consultation to a charity.

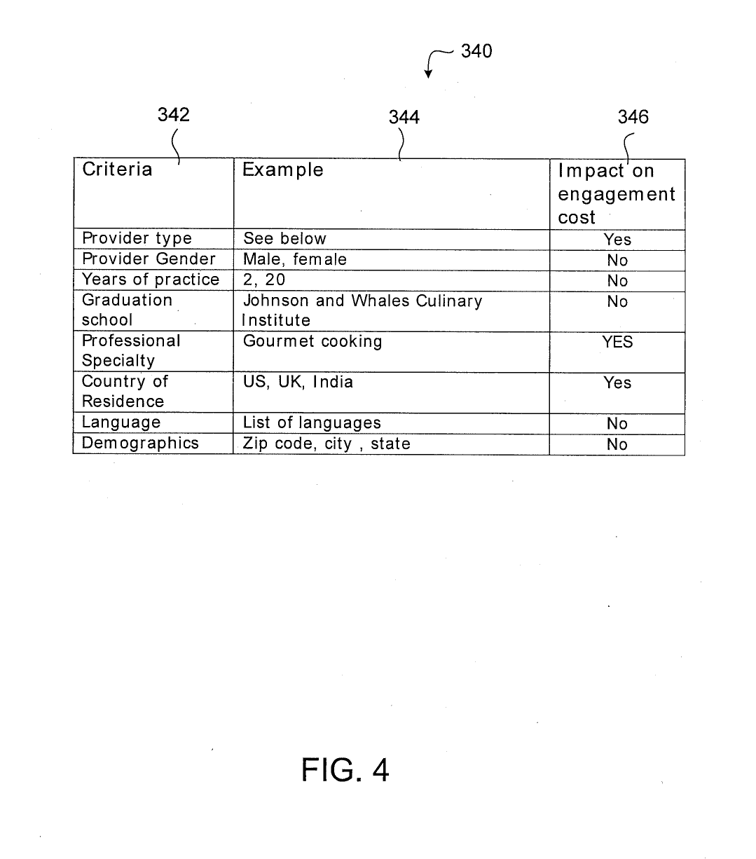

Some information about the provider is verified by the brokerage (e.g., Tax ID, education, professional certification, demographics, and contact information), and some is acquired during the provider's participation on the brokerage. Such data may include length of service, number of engagements, consumer satisfaction, projected availability, etc. A provider may also provide a general introductory note, a picture, and voice and video welcome snippets. Providers may also add other information they deem relevant for consumers (e.g., a list of publications and honorary appointments). A table 340 in FIG. 4 lists example profiling criteria that can be populated during enrollment. The table 340 includes example criteria 342, specific examples 344 of each criterion 342, and an indication 346 of whether that criterion would have an impact on engagement cost.

Individual service providers are also able to register and enroll with the system. Individual service providers are independent service providers not affiliated with a provider network.

As part of the provider selection process described above, consumers benefit from access to introductory material from the provider. As consumers search for providers to meet their needs, they can select to view only providers where such material is available, producing an incentive for providers to take advantage of such capability.

### Provider Ratings

To further improve the ability of consumers to choose appropriate service providers, the brokerage includes a utility for rating the products and services provided by the service providers or by a service provider network. The consumers provide feedback (positive and negative) to the system about the products and services provided by a particular service provider. In addition, the service providers provide feedback and evaluations of the products and services provided by other service providers.

As part of the provider profile (and as a way for consumers to limit their search), the system continuously updates each provider's profile with metrics reflecting the quality of his or her interaction with consumers. The metrics are updated at the conclusion of every engagement to allow providers immediate feedback as to their level of service. In some examples, all searches for providers on the system are sorted by provider rating by default, promoting higher-quality providers. Example parameters to be updated and taken into account in setting the rating include consumers' overall ranking of the provider's engagement quality, the number of engagements made by this provider in the last 30 days or overall, the number of returning engagements as a fraction of all engagements for that provider, the number of redirected engagements from this provider to another, and the average turnaround time for messaging while not “out-of-office.” In addition to the ratings each provider on the system has a Provider Statistic Manifest stating operational statistics that may interest consumers, such as that provider's availability for phone conferences over the last 30 days.

Consumers are asked to rank a provider at the end of the engagement as part of the process of disconnecting. To encourage consumers to provide such feedback, charges for the engagement continue to accrue until the consumer completes the ranking. Such a process helps encourage provider engagements to end with a ranking entry, promoting a higher quality of service to the brokerage's consumers.

The Provider Console

Providers interact with consumers through a provider console web page. This interface is similar to that used by the consumers. The provider console provides access to the various tools used by providers. A window shows a live image of the consumer, with tools to control or disable the video feed. A phone control allows the provider to initiate a phone call with the consumer. A log of an ongoing chat is displayed above an input for the provider's next comment. Other tools are available in tabs on the side, such as accesses to the terms of operation and the legal policies of the brokerage, such as disclaimers. State setting allows the providers to change his availability state between states such as off-line, on-line and out-of-office. Scheduling allows providers to update their availability calendar with future times they expect to be available on the system, which can in turn result in consumers seeing a “scheduled” state for such providers.

Messaging tools allow providers to correspond with consumers in message-based engagements. The console also allows the provider to participate in chat engagements where the consumer and the provider communicate back-and-forth in real-time by typing. The brokerage allows a single provider to engage in more than one chat at a time to maximize his yield while consumers are typing their entries. The chat feature also allows the provider to forward specific lists of questions to further reduce the need for his time in acquiring information from the consumer at the beginning of an engagement. Tools available to assist the provider in chat or messaging may include a thread viewer, the consumer's engagement history, a communication timeline chart, and a library of built-in and self-produced message templates for quick response, and a knowledgebase for sales and support agents (e.g., when the system is used in private operator mode). Such templates may also include references, links, and embedded graphical educational content on prevalent topics. In some examples, the brokerage scans outbound messages for inappropriate language based on the sponsor's preferences.

The console allows the provider to hold a voice conference engagement with the consumer when the consumer is using either her computer or a telephone. The provider can use the console to redirect his end of the conference to a phone, for example, if bandwidth or other considerations indicate it or simply based on personal preference. The console also allows the provider to engage in video conferences with consumers. Audio may be served via the console or be may redirected to a telephone. To verify a provider's identity when using the telephone for a voice engagement, the system provides the provider with a PIN number through the provider console. When the provider calls into the system, or answers the phone when called by the system, the provider enters the PIN to confirm that the person on the phone is the same person who is logged into the console. This method is also used to leave secure voice message. When a provider wants to leave a message for a consumer, the provider requests permission from the console to leave a message and receives a PIN that allows the provider to leave the message. The provider receives a call from the system, enters the PIN, and leaves the message. The message is delivered to the consumer. The use of the PIN provides an assurance that the message was left by the provider.

The provider is able to review his account status, system settings, and preferences. The provider can also access his profile and user satisfaction and statistics as they are available to consumers. The console also connects to financial services associated with the provider's participation in the brokerage. This includes status of charges. The brokerage offers providers the ability to redirect messages or requests for appointment to SMS-compatible cellular phones. In this mode, the provider associates a cell phone number with his account and establishes the type of information that the system can send to the mobile device. Such information may include engagement-related notifications as well as system-related notifications (e.g., an announcement about a high-traffic state asking providers to make themselves available and offering a higher fee to do so).

### Sample Use Cases in an Online Marketplace of Providers and Consumers

The brokerage system acts a marketplace in which various types of providers of services (e.g., astrologers, librarians, and gardeners) sell time to a large marketplace of consumers. Providers of services sell time in the form of consultations (e.g., consultations regarding astrology or gardening) and consumers buy the providers' time. Because individuals do not need to be licensed with a specific industry to sell time through the brokerage system and the brokerage system may not be specific to an industry, the brokerage system is open to various types of individuals to list their consulting services and time for sale.

Using digital recording devices (e.g., a video-camera, a mobile device, and a BlackBerry™) and a client system 132, providers and other various individuals sell over a network (e.g., the Internet or an intranet) consulting services, including services pertaining to library services, astrology services, gardening services (e.g., lessons relating to how to properly plant a garden), cooking services (e.g., online cooking lessons), singing services (e.g., online singing lessons), and dancing services (e.g., online dancing lessons).

Because of the large number of various types of providers selling time through brokerage system, the system includes a navigational component through which consumers browse the various types of service providers available for a consultation. In some examples, consumers access the marketplace through an online webpage that is accessible from a uniform resource location (“URL”). The first page of the webpage includes the navigational components (e.g., links, dropdown menus and so forth) through which the consumer navigates to and/or selects the type of provider with which the consumer would like to engage in a consultation.

The brokerage system may be integrated with a third-party navigational component (i.e., the Craigslist™ webpage or the eBay™ webpage). For example, the consumer accesses the www.craigslist.com webpage and navigates through the various links provided by the www.craigslist.com webpage to select the type of service provider with whom the consumer would like to engage in a consultation. As described in more detail below, the brokerage system determines a list of service providers who are presently available and who match the type of service provider with whom the consumer would like to engage in a consultation. The individual provider entries in the list include a link, which when selected causes a graphical user interface to be rendered on the consumer's display device, with the graphical user interface prompting the consumer for identifying information (e.g., name information and credit card information). The consumer enters the identifying information and the brokerage system processes payment for the consultation and establishes a communication channel between the consumer selecting the link and the service provider associated with the selected link.

As described above, the brokerage system may be operated by one company and the navigational components may be operated by another company (e.g., Craigslist™ or eBay™). When a consumer enters payment information into the fields of the graphical user interface, the operator of the brokerage system processes the payment information and charges the consumer a transaction fee, which is collected by the operator. The operator also disburses payment to the provider with whom the consumer is engaging in the consultation, e.g., by crediting an account (e.g., a bank account) of the provider with a compensation amount.

Providers of services may want to generate income or other revenue by making their real-time, services accessible to consumers over the network. Using the techniques described herein, providers at their discretion become “available” on the brokerage system 100. In some examples, when a provider becomes “available,” this provider availability indicates that the provider will be selling the provider's time and be available for a real-time consultation.

The brokerage system 100 determines the real time, discretionary availability of the providers. Based on this determination, the brokerage system 100 matches a consumer with an available provider and establishes a connection (e.g., a communication channel) between the consumer and the provider. Specifically, the brokerage system 100 matches consumers 120 with providers 130 based on consumer specified attributes for the type of consultation the consumer would like to purchase. The system 100 enables the consumer 120 to search for providers 130 who are providing consultation services at the time the consumer 120 is searching and enables the consumer 120 to engage a provider 130 on a transactional basis in a real-time consultation. In some embodiments, more than one consumer 120 can engage in the same consultation at that same time. In other embodiments, consumer 120 engages in a private consultation with a service provider for a premium fee.

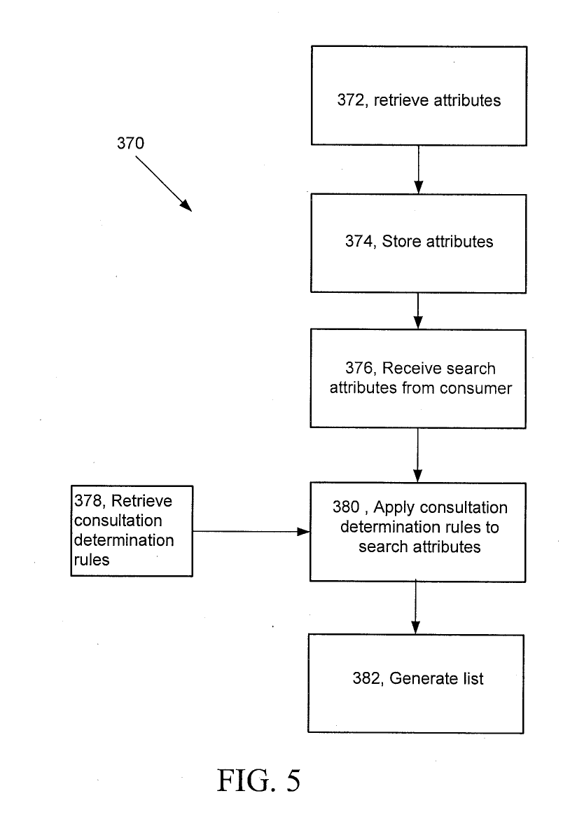

Referring to FIG. 5, the server 110 matches 380 a consumer 120 with a provider 130 that is willing to sell service time to potential consumers. The server 110 receives (372) from the provider 130 an electronic message that includes attributes of services that the provider is selling over the network 140. The server 110 stores (374) the attributes associated with the services that the provider is offering, for example, in database 118 (FIG. 1). The server 110 receives (376) from the consumer 120 search attributes specifying the types of services the consumer would like to purchase and/or the type of consultation time the consumer would like to purchase from a service provider. The server 110 retrieves (378) from the database 118 consultation determination rules. Generally, the consultation determination rules include instructions to compare the search attributes to the attributes associated with the various service providers that are currently available on the brokerage system. The server 110 applies (380) the consultation determination rules to the search attributes to determine service providers associated with attributes matching the search attributes. The server 110 also generates (382) a list of service providers with attributes matching the search attributes. In an example, server 110 also determines the present availability of service providers with attributes matching the search attributes. In this example, the list includes information indicative of service providers with attributes matching the search attributes and who are presently available for a real-time consultation (e.g., are selling consultation time and are presently available for the consultation).

To make a provider's services (e.g., expertise and advice) accessible in real-time through the brokerage system 100 to consumers 120, a provider 130 registers with the brokerage system, for example, by sending the brokerage system 100 an instruction or an electronic message (e.g., electronic mail messages, text messages or short message service (“SMS”) messages) including the attributes indicative of the type of consultation and advice the provider is selling over the network 140. The attributes also specify a date and a time for which the advice is provided and sold in real-time. The attributes include keywords, a text description, data tags and time and date information for when the provider is selling the services.

In one particular example, the provider 130 sends the server 110 an electronic message specifying that the provider is available to engage in a consultation regarding astrology (i.e., the provider is selling advice regarding astrology) on Jan. 11, 2010 from 10 am to 12 pm. In this example, the keywords include “astrology, stars, and galaxy.” In another example, the provider 130 sends the server 110 an electronic message specifying that the provider is available to engage in a consultation regarding cooking (i.e., the provider is selling his cooking advice) on Feb. 2, 2010 from 9 pm to 11 pm. In this example, the keywords include “food, cook, gourmet, and dishes.” Additionally, the attributes also include a description of the type of consultation sold by the provider. An example description includes “a consultation with a skilled chef on how to make quick and healthy meals.” The server 110 also includes keyword generation rules that generate a list of keywords based on the provider's entered description.

The database 118 includes live consultation entries, including, e.g., a record or a file including information associated with a provider's live consultation. A live consultation entry is associated with or linked (e.g., through a pointer) with the attributes for the provider (e.g., data indicative of the type of live consultation sold by the provider and the date and the time the provider is available for the live consultation). Generally, a pointer includes a reference from one data structure to another data structure. When the server 110 receives the provider's electronic message, the server 110 generates a live consultation entry for the consultation sold by the provider. The server 110 parses the electronic message for the attributes indicative of the type of consultation (e.g., the keywords) and indicative of the date and time in which the provider is selling his consulting services. Based on the parsed attributes, the server 110 links the attributes included in the electronic message to the live consultation entry.

To search for providers selling consultation services, a consumer 120 accesses the brokerage system 100 over the network 140 and sends the server 110 an electronic message including search attributes (e.g., keywords or a text description) of the type of consultation the consumer 120 would like to purchase. The server 110 generates a graphical user interface that when rendered on a display device renders a visual representation of search fields (e.g., text boxes). The consumer inputs into the search fields the various search attributes (e.g., keywords or a written description) for the type of type of consultation the consumer 120 would like to purchase. In one particular example, the consumer 120 inputs the following attributes into the search fields: “advice on how to cook crème brûlée.” The search attributes are sent from the consumer's client system 122 over the network 140 to the server 110.

The server 110 receives the search attributes, retrieves the consultation determination rules from the database 118 and executes the consultation determination rules to determine providers selling consultation services associated with at least some of the search attributes specified in the search fields. The consultation determination rules compare the search attributes to the attributes linked with live consultation entries in the database 118. When the search attributes match (e.g., exact match, similar match or some variation thereof) the attributes for a particular live consultation entry, the server 110 determines a matched consultation database entry indicative of a provider selling consultation services in which the consumer 120 may be interested. In the example described above where the search attributes include “advice on how to cook crème brulee,” the server 110 determines through the application of the consultation determination rules providers who are presently available and selling consultation services regarding cooking.

The server 110 generates a list of service providers (“matched service providers”) associated with attributes matching the consumer's search attributes based on the matched consultation database entries. The server 110 sends the consumer 120 the list of the matched service providers. The server 110 generates an electronic message including the list of the matched service providers and sends the electronic message to the consumer's client system 122. The server 110 also generates a graphical user interface that when rendered on a display device renders a visual representation of the list and a visual representation of the service providers included in the list. The service providers included in the list are associated with a link, selection of which causes establishment of a connection between the consumer's client system 122 and the provider's client system 132. Through the connection, the consumer's client system 122 receives streamed data and/or real-time images from the provider's client system 132 that enables the consumer 120 to engage in a real-time consultation with the provider. Additionally, through the connection, the consumer 120 also provides or streams a real-time, live video, enabling the consumer 120 and the provider 130 to both provide and engage in a real-time consultation simultaneously.

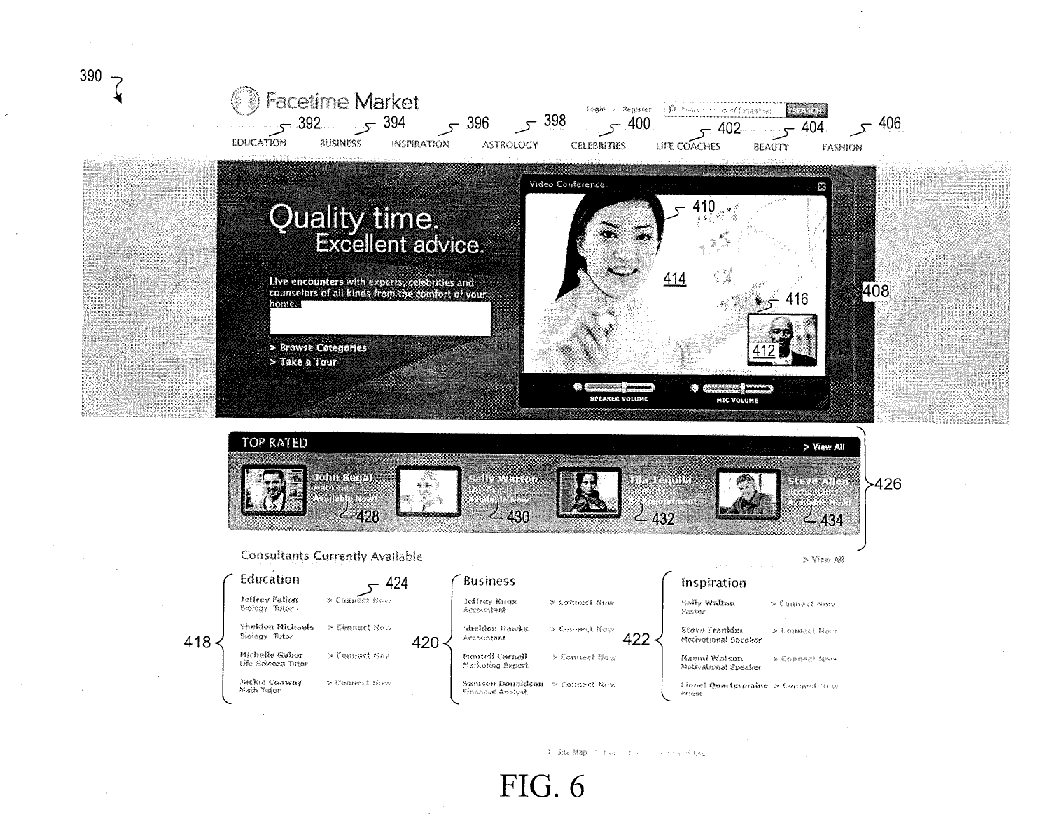

Referring to FIG. 6, system 100 generates graphical user interface 390 that when rendered on client device 132 depicts visual representations of controls through which a consumer can select a service provider and initiate a communication with the service provider. Graphical user interface 390 includes links 392, 394, 396, 398, 400, 402, 404, 406, selection of which enables the consumer to search for various types of service providers. For example, link 392 pertains to service providers in the field of education. Following selection of link 392 by a consumer, system 100 sends to client device 132 a graphical user interface that displays a list of service providers in the field of education that are presently available for a consultation with the consumer. Additionally, through the graphical user interface, the consumer may also search for service providers in the field of education that satisfy certain criteria specified by the consumer (e.g., educational consultants with over ten years of experience, tutors in the metro new york city area, and so forth).

Graphical user interface 390 also includes section 408, which renders a representation of a video conference between service provider 410 and consumer 412. Section 408 includes display 414, which displays a live-feed of service provider 410 providing the consultation services. Section 408 also includes display 416, which displays a live-feed of consumer 412 engaged in the consultation.

Graphical user interface 390 also includes sections 418, 420, 422, which display information specifying service providers that are available in various fields and industries, including, e.g., the educational field, the business field, and the inspirational field. Section 418 includes link 424, through which a consumer can initiate a consultation with a service provider that is presently available in a particular field. In an example, link 424 is a “one-click” link through which the brokerage system immediately establishes a communication channel between a consumer and a selected service provider, e.g., following selection of the link by the consumer.

Graphical user interface 390 also includes section 426, which includes “top rated” service providers. The top-rated service providers include those service providers that have received higher rankings from consumers, e.g., relative to the rankings received for other service providers. Section 426 also includes status indicators 428, 430, 432, 434 to indicate an availability status of the top rated service providers. Top rated service providers may be associated with various types of availability statuses, including, e.g., “available,” “busy,” “available by appointment,” and so forth.

### Private Labeling

The brokerage system can be privately labeled, for example, by customizing the graphical user interfaces generated by the brokerage system for a particular entity or business (e.g., a private business, a public business, and so forth). In an example, the graphical user interfaces are customized for a particular entity by including a logo of the entity on the graphical user interfaces.

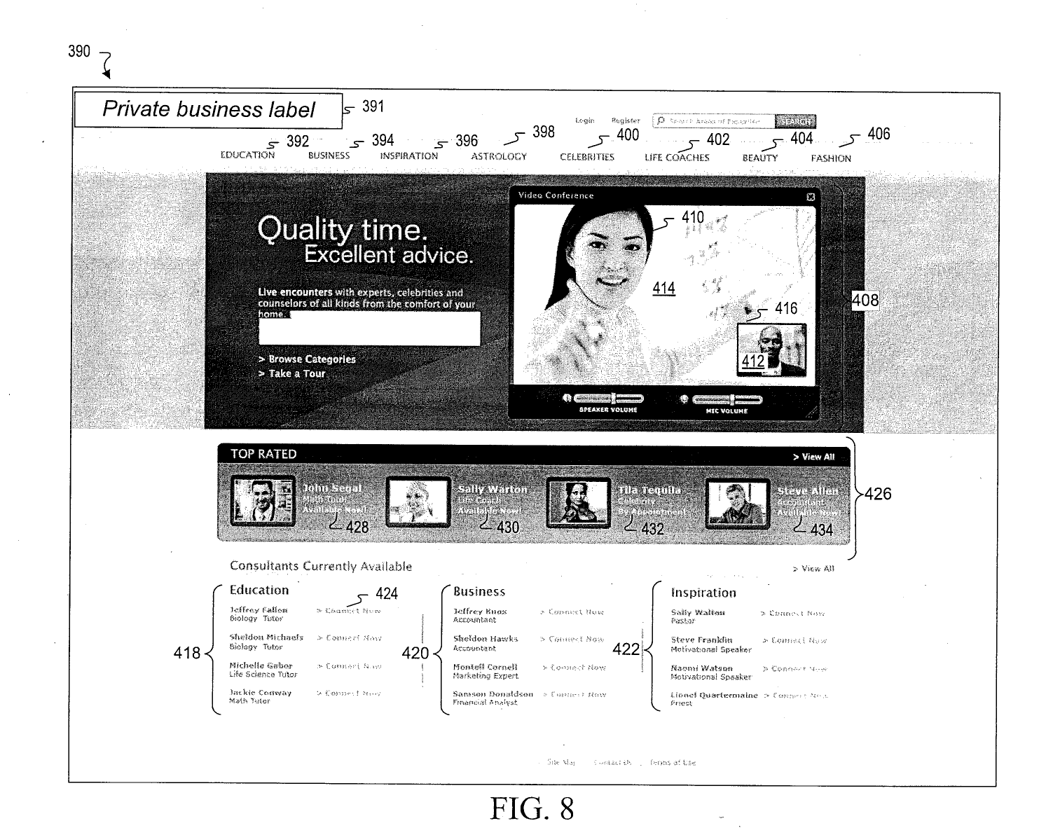

Referring to FIG. 8, graphical user interface 390 includes private business label 391. In this example, private business label 391 includes a visual representation of a marking that identifies (e.g., “labels”) graphical user interface 390 as being associated with the private business. In another example, the brokerage techniques described herein are implemented for a particular business label, for example, to match service providers associated with a particular business with consumer.

For example, through the brokerage system, a particular business or industry sector generates a marketplace of buying and selling service provider time that is specific to that business or industry sector. In one particular example, a law firm implements the brokerage system to generate a marketplace of attorneys from that firm who are available to consult with consumers. In this example, the law firm hosts the brokerage system on its own computing devices (e.g., servers) or accesses external servers hosting the brokerage system. The attorneys associated with the law firm are provided with brokerage system accounts. As described herein, the brokerage system detects the present availability of the attorneys. In some examples, the brokerage system detects the present availability of an attorney when the attorney logs into the brokerage system. In other examples, the brokerage system detects the present availability of the attorney by detecting when the attorney is using a computer or has stopped using a computer for a predefined period of time (e.g., 15 minutes).

Through the law firm's website, the brokerage system 100 receives a request from a consumer to engage in a real-time consultation with one of the law firm's attorneys. Because the law firm collects payment information from the consumer, the consumer is sent a graphical user interface with fields in which the consumer enters identifying information (e.g., name information, identity information and credit card information). In this example, the brokerage system 100 and/or computing devices associated with the law firm collect and process payment for the real-time consultation. The attorneys also send a message to the system 100 indicating the date and times in which the attorneys are available. Additionally, the brokerage system determines the present availability of one of the attorneys associated with the law firm, as described herein. Through a graphical user interface, the consumer is presented with a visual representation of the list of attorneys presently available to engage in a consultation with the consumer. Each of the attorneys included in the list is associated with a link, which when selected by the consumer, causes a real-time communication channel to be established between the consumer and the selected attorney.

In another example, a religious organization (e.g., the Catholic church) implements the brokerage system 100 under a private label. Through the brokerage system, priests generate profiles and make themselves available (e.g., around the world). Using the techniques described above, the brokerage system 100 tracks the present availability of the priests. Consumers seek time with the priests based on the consumer's preferences (e.g., the type of priest with whom a consumer would like to consult or the geographical location of a priest). Additionally, consumers may make payments to the Catholic church using the payment system described above, in which the brokerage system 100 processes the payment. By implementing the brokerage system 100 under a private label, an organization (e.g., a religious organization) generates a global marketplace for the providers associated with the organization, even while the providers are geographically distributed throughout various worldwide locations.

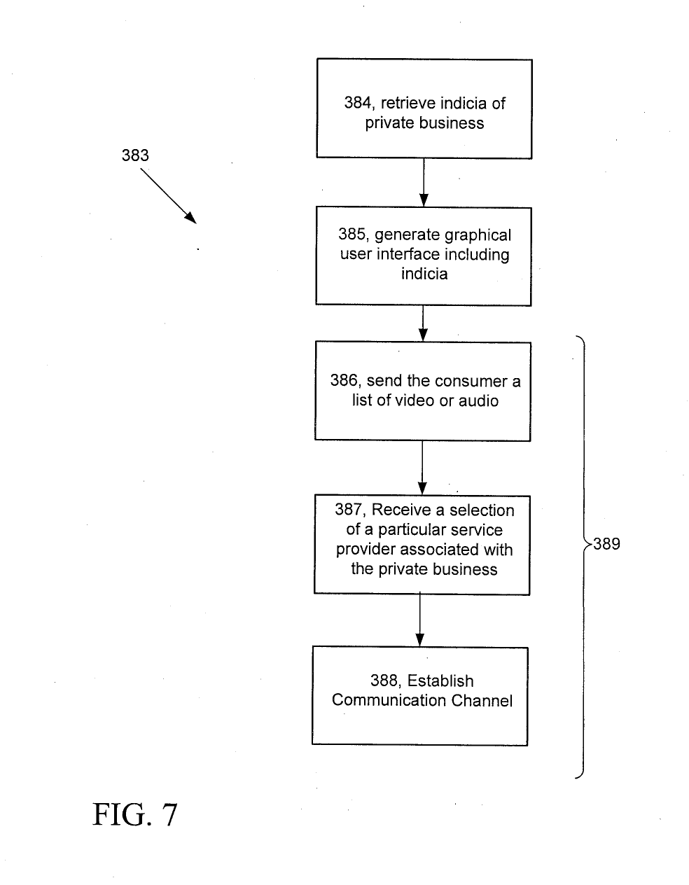

Referring to FIG. 7, brokerage system 100 implements process 383 to execute the brokerage techniques described herein for a particular business and/or for a private label. In operation, system 100 retrieves (384) indicia of a private business, including, e.g., a logo or other image associated with the business, a label for the business, and so forth.

System 100 generates (385) a graphical user interface (e.g., graphical user interface 390) that includes a pictorial representation of the indicia (e.g., private business label 391). In an example, consumer 120 accesses graphical user interface 390 associated with private label 391 via client system 122. Through graphical user interface 390, consumer 120 submits a request for a provider associated with the private business and satisfying certain criteria.

In response, system 100 also sends (386) the consumer a list of video (e.g., section 426 in FIG. 8) or audio for the consumer to select from to view to assist the consumer in selecting a provider. In an example, the video may include live video and/or pre-recorded video. In this example, the video may include an introductory video in which the provider gives an overview of the offered services. In another example, service provider 130 at client device 132 may use a web cam to stream live video to consumer 120 at client device 122.

System 100 also receives (387) from client device 122 a selection of a particular service provider that is presently available and associated with the private business. In an example, the selected service provider also satisfies at least some attributes included in the request from the consumer. System 100 establishes (388) communication channel between client device 122 and client device 132, e.g., following selection of the consumer's selection of a particular service provider.

### Organizations Connecting Support and Sales Professionals

The brokerage system 100 is also used to connect support and sales professionals with consumers. In one example, a company runs a contact center and employs a large number of sales and support professional. A consumer (e.g., consumer 120) sends a request to the brokerage system 100 (e.g., hosted internally by the company or hosted externally by a third-party vendor) to engage in a consultation with a support professional (e.g., service provider 130). In one particular example, a consumer browsing the company's website has a question (e.g., a question regarding a feature of a product sold by the company) and through a graphical user interface sent to the consumer's display device (e.g., client device 122) requests (e.g., through selection of a link) to be connected to a support professional, enabling the consumer to engage in a real-time consultation with the support professional.

In another example, the system detects the consumer's request to engage in a consultation with a support professional. The system is able to detect the consumer's request using various behavior prediction techniques and browsing pattern techniques, including learning that a consumer has repeatedly selected a link or button associated with the company's website (e.g., the consumer has repeatedly selected the “search” button associated with the company's online knowledge base).

The brokerage system 100 receives the request (or a copy of the request forwarded to it by the private company's computing devices) and determines one of more support professionals presently available for the consultation, as described in further detail below. Additionally, the brokerage system 100 also determines, through the execution of rules, support professionals who are appropriate to engage with a consumer (e.g., are knowledgeable in the area in which the consumer seeks advice and so forth).

In one example, the support professionals are associated with an area of expertise (e.g., electronics, personal health products, exercise equipment, and so forth). When the brokerage system detects that a consumer requests to engage in a consultation with a support professional, the brokerage system also makes a determination of the area of expertise in which the consultation is needed. The rules provide a mapping between the area of expertise in which the consultation is requested and the type of support professional appropriate for the requested consultation. For example, if the brokerage system determines that a consumer requests to engage in a consultation with a support professional regarding a laptop computer, a rules engine executes the rules to determine that a support professional in the area of electronics is best suited to engage in a consultation with the consumer.

The rules also provide a mapping between the attributes of the support professional (e.g., languages spoken or percentage of consumers who gave the support professional a high support professional ranking) and the attributes of the consumer to determine a support professional who is a “best fit” for the consumer. In one particular example, if the consumer only speaks Spanish, then through the execution of the rules, the rules engine determines that a support professional who is fluent in Spanish is a best fit for the consumer.

Through the brokerage system 100, the private company enables the consumer to engage in a consultation with a support professional free of charge as a way of funneling traffic into the company's website and enticing consumers to purchase other products (e.g., electronics, sporting good and books) and services (e.g., a service contract) from the private company. Through the brokerage system's established communication channel, the consumer is connected to a support professional for a real-time consultation (e.g., voice and/or video engagement), without being prompted for payment information because the consumer is not paying for the consultation. Because the consumer is not paying for the consultation, the brokerage system does not receive information (e.g., name information, identity information and credit card information) identifying the consumers.

In some examples, the consumer requests to engage in a real-time consultation with a support professional through the company's website (e.g., www.bestbuy.com). The website includes a link (e.g., “Click here to talk to a customer representative”). When the consumer selects a link, a request is sent to the brokerage system to identify a support professional that is presently available and appropriate and/or a “best fit” based on the execution of the rules for the consultation.

The support professional also sends a message to the system 100 indicating the date and times in which the support professional is available. The brokerage system 100 identifies a support professional that is presently available and establishes a real-time communication between the presently available support professional and the consumer, using the techniques described herein. When more than one support professional is presently available, the brokerage system employs various techniques to determine which support professional to connect to the consumer. These techniques include tracking an amount of time a support professional has been “idle” or otherwise not engaged in a consultation with a consumer and selecting the support professional who has been idle the longest. These techniques also include selecting the support professional who has most recently become available on the brokerage system and who is best suited to provide expertise to the consumer based on the execution of the rules.

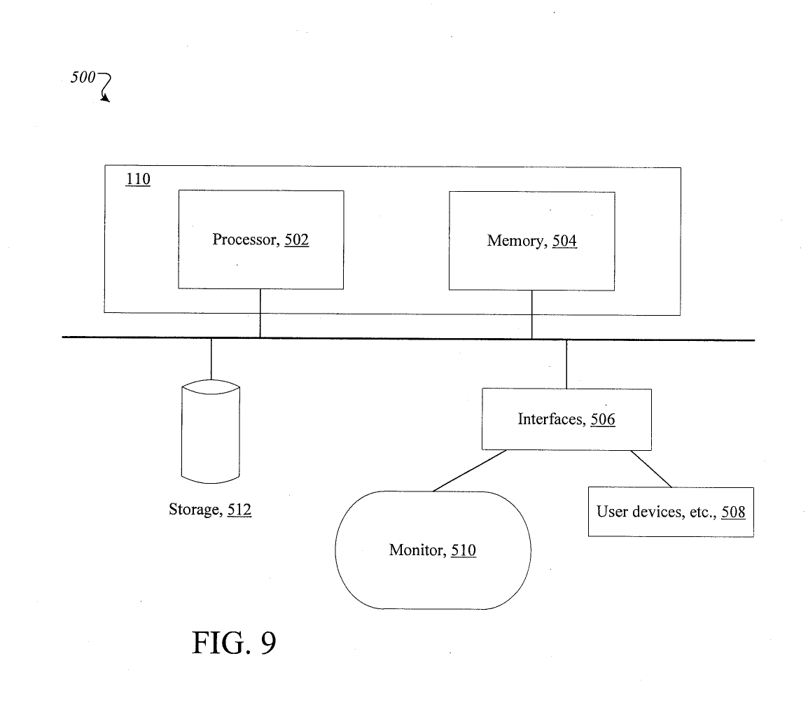

FIG. 9 is a block diagram of components 500 of the engagement brokerage system. User devices 508 can be any sort of computing device capable of taking input from a user and communicating over a network (not shown) with server 110 and/or with other client devices. For example, user device 508 can be a mobile device, a desktop computer, a laptop, a cell phone, a personal digital assistant (“PDA”), a server, an embedded computing system, a mobile device and so forth. User devices 508 include monitor 510 which render visual representations of interface 506.

Server 110 can be any of a variety of computing devices capable of receiving information, such as a server, a distributed computing system, a desktop computer, a laptop, a cell phone, a rack-mounted server, and so forth. Server 110 may be a single server or a group of servers that are at a same location or at different locations.

Server 110 can receive information from client device user device 508 via interfaces 506, including, e.g., graphical user interfaces. Interfaces 506 can be any type of interface capable of receiving information over a network, such as an Ethernet interface, a wireless networking interface, a fiber-optic networking interface, a modem, and so forth. Server 110 also includes a processor 502 and memory 504. A bus system (not shown), including, for example, a data bus and a motherboard, can be used to establish and to control data communication between the components of server 110.

Processor 502 may include one or more microprocessors. Generally, processor 502 may include any appropriate processor and/or logic that is capable of receiving and storing data, and of communicating over a network (not shown). Memory 504 can include a hard drive and a random access memory storage device, such as a dynamic random access memory, machine-readable media, or other types of non-transitory machine-readable storage devices.

Components 500 also include storage device 512, which is configured to store information collected through the brokerage system during a service provider's consultation with a consumer.

Embodiments can be implemented in digital electronic circuitry, or in computer hardware, firmware, software, or in combinations thereof. Apparatus of the invention can be implemented in a computer program product tangibly embodied or stored in a machine-readable storage device and/or machine readable media for execution by a programmable processor; and method actions can be performed by a programmable processor executing a program of instructions to perform functions and operations of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

Other embodiments are within the scope and spirit of the description claims. In an example, the brokerage services described herein may be applied to numerous, different types of service providers, including, e.g., medical professionals, physicians, nurses, and so forth. In another example, due to the nature of software, functions described above can be implemented using software, hardware, firmware, hardwiring, or combinations of any of these. Features implementing functions may also be physically located at various positions, including being distributed such that portions of functions are implemented at different physical locations.

What is claimed is:

1. A computer-implemented method comprises:
receiving a request from a consumer to purchase consultation time from a service provider having specified attributes, the service providers associated with a private business;
generating a graphical user interface that when rendered on a display device depicts an image marking the graphical user interface with a indicia of the private business and one or more input elements for searching for the one or more service providers associated with the private business;
determining by a computer system one or more service providers associated with the private label that are presently available to engage in a real-time consultation with the consumer;
searching by the computer system a database of attributes for the one or more presently available service providers selling consultation time; and
identifying a presently available service provider associated with at least some of attributes included in the request to purchase consultation time.

2. The computer-implemented method of claim 1, further comprising:
establishing a communication channel between a computer system of the identified service provider and a computer system of the consumer.

3. The computer-implemented method of claim 1, wherein the attributes for a service provider comprise one or more of a date on which the consultation time of the service provider is sold and a field related to the consultation provided by the service provider.

4. The computer-implemented method of claim 1, further comprising:
receiving from a computer system of the consumer payment information for purchase of the consultation time;
processing the payment information; and
crediting an account of the identified service provider with a compensation amount.

5. The computer-implemented method of claim 1, wherein the service provider is a customer service representative.

6. The computer-implemented method of claim 1, wherein receiving the request to purchase consultation time comprises:
receiving information indicative of one or more actions performed by the consumer in a graphical user interface generated by the computer system; and
detecting, based on the one or more actions, the request to purchase consultation time.

7. The computer-implemented method of claim 1, wherein the identified service provider is a first type of service provider, and wherein the method further comprises:
generating a graphical user interface that when rendered on a display device depicts:
a first visual representation of the first type of service provider that is available for a first type of consultation with the consumer; and
a second visual representation of a second, different type of service provider that is available for a second, different type of consultation with the consumer.

8. The computer-implemented method of claim 1, further comprising:
sending the consumer a list of video or audio for the consumer to select from to view to assist the consumer in selecting a provider.

9. One or more machine-readable media configured to store instructions that are executable by one or more processing devices to perform operations comprising:
receiving a request from a consumer to purchase consultation time from a service provider having specified attributes, the service providers associated with a private business;
generating a graphical user interface that when rendered on a display device depicts an image marking the graphical user interface with a indicia of the private business and one or more input elements for searching for the one or more service providers associated with the private business;
determining one or more service providers associated with the private label that are presently available to engage in a real-time consultation with the consumer;
searching a database of attributes for the one or more presently available service providers selling consultation time; and
identifying a presently available service provider associated with at least some of attributes included in the request to purchase consultation time.

10. The one or more machine-readable media of claim 9, wherein the operations further comprise:
establishing a communication channel between a computer system of the identified service provider and a computer system of the consumer.

11. The one or more machine-readable media of claim 9, wherein the attributes for a service provider comprise one or more of a date on which the consultation time of the service provider is sold and a field related to the consultation provided by the service provider.

12. The one or more machine-readable media of claim 9, wherein the operations further comprise:
receiving from a computer system of the consumer payment information for purchase of the consultation time;
processing the payment information; and
crediting an account of the identified service provider with a compensation amount.

13. The one or more machine-readable media of claim 9, wherein receiving the request to purchase consultation time comprises:
receiving information indicative of one or more actions performed by the consumer in a graphical user interface generated by the computer system; and
detecting, based on the one or more actions, the request to purchase consultation time.

14. The one or more machine-readable media of claim 9, wherein the identified service provider is a first type of service provider, and wherein the operations further comprise:
generating a graphical user interface that when rendered on a display device depicts:
a first visual representation of the first type of service provider that is available for a first type of consultation with the consumer; and
a second visual representation of a second, different type of service provider that is available for a second, different type of consultation with the consumer.

15. The one or more machine-readable media of claim 9, wherein the operations further comprise:
sending the consumer a list of video or audio for the consumer to select from to view to assist the consumer in selecting a provider.

16. An electronic system comprising:
one or more processing devices; an
one or more machine-readable media configured to store instructions that are executable by the one or more processing devices to perform operations comprising:
receiving a request from a consumer to purchase consultation time from a service provider having specified attributes, the service providers associated with a private business;
generating a graphical user interface that when rendered on a display device depicts an image marking the graphical user interface with a indicia of the private business and one or more input elements for searching for the one or more service providers associated with the private business;
determining one or more service providers associated with the private label that are presently available to engage in a real-time consultation with the consumer;
searching a database of attributes for the one or more presently available service providers selling consultation time; and
identifying a presently available service provider associated with at least some of attributes included in the request to purchase consultation time.

17. The electronic system of claim 16, wherein the operations further comprise:
establishing a communication channel between a computer system of the identified service provider and a computer system of the consumer.

18. The electronic system of claim 16, wherein the attributes for a service provider comprise one or more of a date on which the consultation time of the service provider is sold and a field related to the consultation provided by the service provider.

19. The electronic system of claim 16, wherein the operations further comprise:
receiving from a computer system of the consumer payment information for purchase of the consultation time;
processing the payment information; and
crediting an account of the identified service provider with a compensation amount.

20. The electronic system of claim 16, wherein the identified service provider is a first type of service provider, and wherein the operations further comprise:
generating a graphical user interface that when rendered on a display device depicts:
a first visual representation of the first type of service provider that is available for a first type of consultation with the consumer; and
a second visual representation of a second, different type of service provider that is available for a second, different type of consultation with the consumer.
